(19) United States
(12) Patent Application Publication
(10) Pub. No.: US 2009/0274615 A1
(43) Pub. Date: Nov. 5, 2009

(54) Device for the Generation of Hydrogen Gas by Dehydrogenation of Hydrocarbon Fuels

(75) Inventors: Peter Jänker, Riemerling (DE); Felix Nitschké, München (DE); Christian Wolff, Ottobrunn (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 11/992,356

(22) PCT Filed: Sep. 2, 2006
(86) PCT No.: PCT/DE2006/001546

§ 371 Date: May 14, 2009

(30) Foreign Application Priority Data
Sep. 20, 2005 (DE) 10 2005 044 926.3

(51) Int. Cl. C01B 3/26; B01J 19/00

(52) U.S. Cl. 423/651; 422/198

(57) ABSTRACT

A device for generation of hydrogen gas by dehydrogenation of hydrocarbon fuels. The device includes a fuel reservoir connected to a reactor by a fuel line to supply said reactor with fuel. The reactor has a first discharge for recycling of residual hydrocarbons generated during dehydrogenation to the fuel reservoir and optionally cooperates with a catalyst. The fuel reservoir may contact a heat exchanger by the fuel line and the first discharge. The fuel may be preheated by the heat exchanger which may be introduced to the reactor by the fuel line and the reactor may have a heating device for heating the introduced fuel to reaction temperature. The residual fuel generated by dehydrogenation in the reactor may be cooled by the heat exchanger and may be returned to the fuel reservoir. The reactor may have a second discharge for the extraction of the hydrogen gas generated on dehydrogenation.

### TECHNICAL AREA

The present invention relates to a device for generating hydrogen gas via the dehydrogenation of hydrocarbon fuels. Based on the preamble of claim 1, the device according to the invention encompasses a fuel reservoir, which is connected with a reactor by a fuel feed line to supply fuel to the reactor from the fuel reservoir, wherein the reactor has a first discharge line for returning the residual fuel generated during the dehydrogenation of the supplied fuel to the fuel reservoir, and the reactor interacts with a catalyst, if required.

### BACKGROUND OF THE INVENTION

As is known, hydrogen gas, especially for use in fuel cells, has previously been generated by reforming hydrocarbon fuels (benzene, diesel, kerosene, etc.) via the supply of a suitable oxidant, such as air or water. This yields byproducts, especially carbon monoxide and carbon dioxide, which necessitates an expensive cleaning process. Further, the disadvantage to onboard hydrogen generation, e.g., through steam reforming, is that the process is relatively complicated, since water must be supplied, which has to either be taken along or generated on board.

One device according to the preamble of claim 1 is known from publication EP 1 069 069 A2, in which, in contrast to the conventionally employed reforming process, relatively pure hydrogen gas is produced without yielding CO, CO₂, NOₓ or other disadvantageous byproducts, thereby avoiding contaminants in the hydrogen gas. Since the hydrogen gas is also not diluted by either N₂ or O₂, this advantageously results in a simple operation of a fuel cell or another hydrogen gas consumer.

However, the device known from publication EP 1 069 069 A2 does have a disadvantage in that it has a complex, cumbersome structural design, and a low energy yield, thereby resulting in a low efficiency.

### DESCRIPTION OF THE INVENTION

Therefore, the object of the invention is to improve a generic device, in particular for onboard hydrogen gas generation in airplanes, in such a way as to provide an energy-optimized arrangement for increasing energy yield and/or efficiency. Another object is to provide as flexible an arrangement as possible with a low weight and low volume.

This object is achieved in a first aspect of the invention by a device having the features in claim 1.

One preferred first embodiment of the invention is characterized in that the fuel reservoir is in contact with a heat exchanger via both the fuel feed line and the first discharge line of the reactor, wherein liquid fuel can be prewarmed by the heat exchanger and supplied to the reactor via the fuel feed line. The reactor encompasses a heater for heating the supplied, liquid fuel to reaction temperature, and the liquid residual fuel generated during the dehydrogenation of the fuel supplied to the reactor can be cooled by the heat exchanger and returned to the fuel reservoir, wherein the reactor has a second discharge line for removing the hydrogen gas (and any contaminants therein) generated during the dehydrogenation of the supplied fuel.

Such an arrangement not only has a compact structure, since several components are effectively combined and/or integrated, wherein in particular the reactor, heater and unit for separating generated hydrogen gas are combined in a technically simple way, but also ensures a higher energy yield, since the arrangement is based on a counter-flow principle, i.e., the fuel feed line used to supply fuel to the reactor and the first discharge line used to remove the residual fuel from the reactor are part of the heat exchanger. In this way, the residual heat present in the system can be optimally used. Since the fuel reservoir is also connected with the heat exchanger, the coldness of the cold fuel stored in the fuel reservoir can also be used. Therefore, a very large share of the overall energy advantageously remains in the system in such an arrangement.

Another advantage to the first embodiment is that the hydrogen gas directly removed from the reactor via the second discharge line usually has a certain residual heat that can generally be useful in later applications, e.g., in a fuel cell.

In a second embodiment of the invention, the fuel feed line and first discharge line also connect the fuel reservoir with the heat exchanger, and the fuel is preheated by the heat exchanger and supplied to the reactor via the fuel feed line, wherein the reactor again has a heater for heating the supplied fuel to reaction temperature. As opposed to the first embodiment, the second embodiment is characterized in that the reaction mixture of hydrogen gas and residual fuel generated during the dehydrogenation of fuel supplied to the reactor can be supplied to the heat exchanger via the first discharge line for cooling purposes, so that the hydrogen gas and residual fuel owing to varying aggregate states can be separated from each other via condensation, wherein the first discharge line can further have an outlet downstream from the heat exchanger for discharging the generated hydrogen gas, which potentially contains gaseous contaminants.

In addition to the advantages already discussed above relating to an improved energy yield for increasing efficiency by connecting the fuel reservoir and heat exchanger and making the structure of the device more compact by integrating the heater into the reactor, the advantage to the second embodiment in particular is that various aggregate states of the fuel supplied to the reactor or the residual fuel generated during dehydrogenation are not problematical, since the hydrogen gas and gaseous or liquid residual fuel can be easily separated via condensation by removing the generated reaction mixture via the first discharge line and the heat exchanger. Further, the advantage to the second embodiment is that the hydrogen gas discharged via the outlet after the heat exchanger is cooler than the hydrogen gas removed directly from the reactor in the first embodiment. For example, the cooler hydrogen gas can be suitably stored on board.

The dehydrogenation of hydrocarbon fuels used in the invention is based on the following endothermic reaction:

CₙHₓ→H₂+CₙHₓ₋₂.

This represents the reversal of the hydrogenation that has already technically take place, and basically enables the generation of pure hydrogen gas and unsaturated hydrocarbons, wherein the latter can again be supplied to the fuel reservoir. Not all hydrocarbons are converted during the reaction, but rather just a portion, i.e., incomplete conversion is sufficient. This is attractive for onboard hydrogen gas generation, e.g., in airplanes, helicopters, motor vehicles or other means of transportation, for the operation of auxiliary aggregates, since the relatively low demand makes a quantitative reaction unimportant, and the unconsumed hydrocarbon fuel portions along with the waste ad reaction products of saturated hydrocarbons can be returned to the fuel reservoir (or directly to the propulsion unit or motor), and constitute only a small and completely harmless chemical change in the hydrocarbon fuel (=mixture of different hydrocarbons).

Since the hydrogen gas generated in both the first and second embodiments usually contains gaseous contaminants, it is advantageous to route the latter to a cleaning unit in order to remove the contaminants, as well be described in greater detail below.

In another advantageous embodiment of the invention, the first and second embodiments can be combined in such a way as to provide both a second discharge line in the reactor, as well as an outlet downstream from the heat exchanger, to respectively remove hydrogen gas, wherein the second discharge line of the reactor and the outlet are connected with each other in such a way, typically by means of a suitable valve switch, that one of the two respective lines can be connected to the cleaning unit.

This brings about an especially variable device for the dehydrogenation of hydrocarbon fuels, so that hydrogen gas with a certain residual heat or cold hydrogen gas can be removed, as required. It is also unnecessary to further modify the device, e.g., if prewarmed, gaseous fuel is supplied to the reactor or gaseous residual fuel is generated in addition to hydrogen gas during dehydrogenation. Opening and closing the valve switch makes it possible to route the respectively generated hydrogen gas with any contaminants contained therein to the cleaning unit to remove the contaminants.

Membrane methods are preferably used in the cleaning unit to separate out contaminants in the hydrogen gas supplied to the cleaning unit. Of course, other suitable methods can also be used for this purpose. The separated contaminant stream is then preferably discharged via a contaminant outlet, and the pure hydrogen gas via a hydrogen outlet.

The contaminant stream removed through the contaminant outlet of the cleaning unit can advantageously again be used for heating the reactor. This can be accomplished by the contaminant stream and utilizing the heat generated in the process for heating the reactor. In addition, the contaminant stream can also be routed through a turbine, to mention just a few examples.

The device according to the invention is preferably used for onboard hydrogen gas generation in airplanes, helicopters, motor vehicles or other means of transportation.

The device according to the invention is especially designed for onboard hydrogen gas generation in airplanes, wherein the reactor can preferably be heated by the bleed-air present in airplanes, or by waste heat from a turbine and/or waste heat from a fuel cell. This makes it possible to heat the reactor in a particularly effective manner, since heat streams present in airplanes are utilized.

During use in airplanes or helicopters, it is further advantageous to use the pressure and/or temperature differences on the ground and in the air for the fractionated distillation of the hydrocarbon fuel, without an added outlay being required for separating readily volatile from sparingly volatile constituents of the fuel. In particular, the sparingly volatile constituents of the fuel can be used for dehydrogenation, which advantageously leads to a reduction in the mass flow.

The object underlying the invention is achieved in a second aspect by a method having the features in claim 13.

In the method for generating hydrogen gas with the device according to the invention, the dehydrogenation of the hydrocarbon fuel supplied to the reactor is controlled in such a way as to generate hydrogen gas on the one hand and residual fuel that can be mixed with the hydrocarbon fuel stored in the fuel reservoir, and characterized in that the hydrogen gas generated in the reactor during the dehydrogenation of supplied fuel is removed directly from the reactor via a second discharge line, and/or the reaction mixture consisting of residual fuel and hydrogen gas generated in the reactor during the dehydrogenation of supplied fuel is removed via a first discharge line and cooled by means of a heat exchanger so as to separate the hydrogen gas from the residual fuel, wherein the separated hydrogen gas with any contaminants contained therein is removed via an outlet provided in the first discharge line and situated downstream from the heat exchanger.

Such a method not only enables an energy efficient generation of hydrogen gas without producing CO, CO₂ or NOₓ, but also makes it possible to easily remove either hydrogen gas still imbued with residual heat or hydrogen gas that has already been cooled, as desired, thereby enabling a high flexibility.

### BRIEF DESCRIPTION OF DRAWINGS

The invention will be described using examples below, drawing references to the attached drawings, which show:

FIG. 1 a schematic view of a first embodiment of the invention;

FIG. 2 a schematic view of a second embodiment of the invention; and

FIG. 3 a schematic view of a third embodiment of the invention.

The same or similar components in the figures are labeled with identical references numbers. The illustrations in the figures are strictly schematic views of the embodiments of the invention, and are not to scale.

### DESCRIPTION OF EXEMPLARY EMBODIMENTS OF THE INVENTION

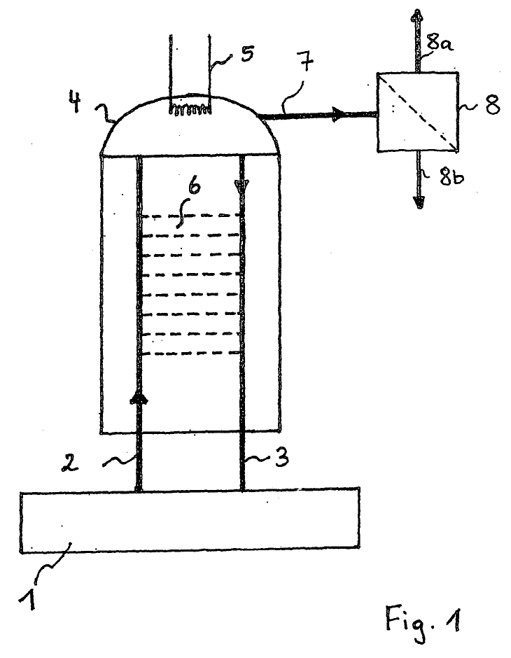

FIG. 1 provides a schematic view of a first embodiment of the invention. The device for generating hydrogen gas via the dehydrogenation of hydrocarbon fuels encompasses a fuel reservoir 1 for hydrocarbon fuels (e.g., kerosene, benzene or diesel). When used for onboard hydrogen gas generation in airplanes, the fuel stored in the fuel reservoir 1 is liquid kerosene, e.g., which typically has a temperature of approx. −60° C. during flight. The fuel reservoir 1 is connected with the reactor via the fuel feed line 2 to supply fuel from the fuel reservoir 1 to the reactor 4. At the same time, the fuel reservoir 1 is coupled with the heat exchanger 6 via the fuel feed line 2 in such a way as supply the fuel to the reactor 4 preheated, i.e., to a temperature below the reaction temperature T_{R}. Therefore, the fuel is heated via the heat exchanger 6 and supplied to the reactor 4, wherein the preheated, supplied fuel generally has a liquid aggregate state. The reactor 4 further encompasses a heater 5, which is used to heat the supplied, liquid fuel to a reaction temperature T_{R} typically measuring approx. 400° C. Heating usually is local, i.e., only the fuel in the heater 5 is heated to a reaction temperature T_{R} for generating gaseous hydrogen, wherein the rest of the fuel supplied to the reactor 4 remains in a liquid aggregate state, and has a lower temperature (<T_{R}). As a result, a two-phase mixture consisting of hydrogen gas and liquid residual fuel is generated in the reactor 4 according to reaction equation CₙHₓ→H₂+CₙHₓ₋₂. This is a partial or incomplete dehydrogenation, since only a portion of the fuel is converted, and other (unsaturated) hydrocarbons are generated as the residual constituent. Such a deliberate incomplete conversion of hydrocarbons into hydrogen gas is completely sufficient for the desired purpose, since a high yield of hydrogen gas is not important here given the expected large fuel reservoir. As opposed to the previously used reforming process, no harmful constituents are advantageously produced, e.g., CO, CO₂ or NOₓ. The above reaction can also be supported by a catalyst (e.g., metals and/or metal oxides).

Since the reaction constituents hydrogen gas and residual fuel are present in different aggregate states, the gaseous hydrogen can be easily removed by way of a second discharge line 7 provided on the reactor 4. The removed hydrogen gas usually contains contaminants that are removed via a cleaning unit 8. For example, this can be accomplished using a membrane method in the cleaning unit 8. Of course, other known cleaning methods are possible. The cleaning unit 8 has an outlet 8a for removing the cleaned hydrogen gas along with a second outlet 8b for removing the contaminants. The liquid residual fuel that remains in the reactor 4 during dehydrogenation is cooled and returned to the fuel reservoir 4 via the first discharge line 3, which is part of the heat exchanger 6 just like the fuel feed line 2. The fact that both the fuel feed line 2 and first discharge line 3 are part of the heat exchanger 6 enables an effective energy exchange, wherein the heat exchanger 6 operates according to the counter-flow principle. Because the fuel reservoir 1 is also in contact with the heat exchanger 6, the coldness of the fuel reservoir 1 can also be used effectively to cool the residual fuel supplied to the fuel reservoir 1 via the first discharge line. This also helps to improve the energy yield of the system.

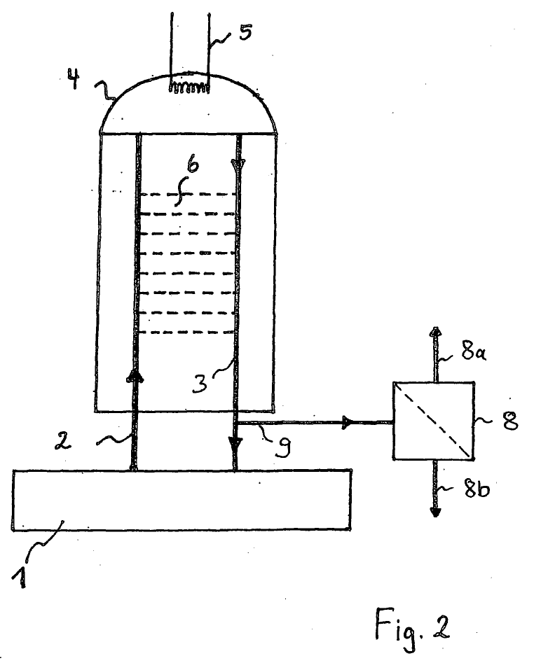

FIG. 2 shows a second embodiment of the device according to the invention. As in the first embodiment, a fuel reservoir 1 is provided, and connected with the reactor 4 via the fuel feed line 2 and heat exchanger 6. The hydrocarbon fuel supplied to the reactor 4 via the fuel feed line 2 from the fuel reservoir 1 is heated with the heater 5 to reaction temperature T_{R}, as in the first embodiment. However, the hydrocarbon fuel stored in the fuel reservoir 1 in the second embodiment can be present in both liquid and gaseous form, even if these generally are in a liquid aggregate state during the use of typical hydrocarbon fuels, such as kerosene, benzene or diesel. The fuel prewarmed and supplied to the reactor 4 can here also be present in gaseous and liquid form. The fuel heated in the reactor 4 by the heater 5 to reaction temperature T_{R} (approx. 400° C.) is then again dehydrogenated according to the above reaction equation in such a way as to yield hydrogen gas and residual fuel. Depending on whether the supplied fuel is only brought to a reaction temperature T_{R} locally as in the first embodiment or in the entire reactor 4, the residual fuel can be in either a gaseous or liquid aggregate state. As opposed to the first embodiment, however, the generated reaction mixture of hydrogen gas and residual fuel is here removed via the first discharge line 3, and cooled by the heat exchanger 6. Cooling makes it possible to separate the hydrogen gas from the residual fuel, wherein the first discharge line 3 has an outlet 9 downstream from the heat exchanger 6, through which the generated hydrogen gas and any contaminants contained therein are discharged. The condensed, liquid residual fuel is again returned to the fuel reservoir 1 if liquid fuel is stored in the fuel reservoir 1. In the event that the fuel in the fuel reservoir 1 is gaseous, this is not possible, or another step would be required for this purpose. Since the hydrogen gas discharged via outlet 9 generally has contaminants, it can again be connected to a cleaning unit 8 which, as described above, separates out the contaminants, so that pure hydrogen gas is discharged via outlet 8a, and the contaminants via outlet 8b.

More energy is recovered for the process in the second embodiment by comparison to the first embodiment, and the hydrogen gas discharged via outlet 9 or outlet 8a can be initially stored in a fuel cell for later use, for example, since it is colder than they hydrogen gas generated in the first embodiment.

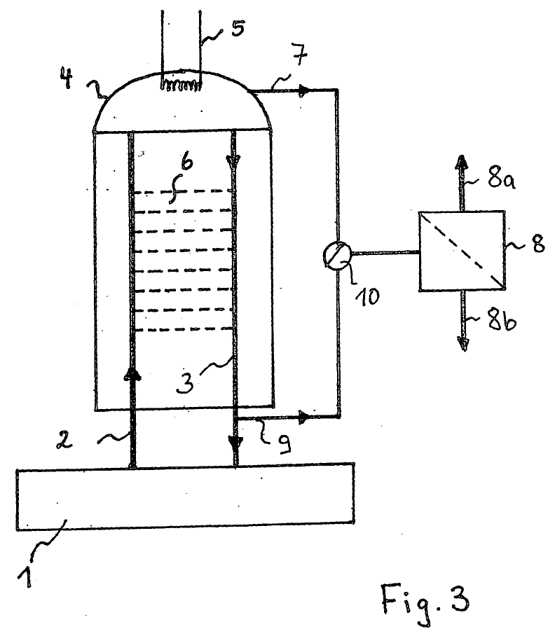

Of course, the two embodiments described above (FIG. 1 and FIG. 2) can also be combined, resulting in the third embodiment of the invention shown on FIG. 3. As evident from FIG. 3, the reactor 4 has both a second discharge line 7 to remove the hydrogen gas generated in the reactor 4 during dehydrogenation directly from the reactor 4, as well as an outlet 9 provided in the first discharge line 3 and situated downstream from the heat exchanger 6. The second discharge line 7 and the outlet 9 are here connected by 6 a valve arrangement 10 in such a way that only one of the respective lines is hooked up to the cleaning unit 8. The cleaning unit 8 here has the same structural design and function as described above. Such an arrangement can also combine the respective advantages of the first and second embodiment, so that either hydrogen gas still imbued with residual warmth or cold hydrogen gas can be removed from the device, as required.

The invention is preferably used for onboard hydrogen gas generation in aircraft (i.e., airplanes and helicopters), motor vehicles or other means of transportation. When used in an airplane, the bleed air present in the airplane is preferably used to heat the reactor. As an alternative, the waste heat from a turbine and/or a fuel cell can also be used to heat the reactor. As a consequence, the heat sources present in an airplane can be effectively utilized for onboard hydrogen gas generation. In addition, the contaminant stream generated in the cleaning unit 8 can also be used for heating the reactor. To this end, the contaminant stream is burned, and the resultant heat can be used for heating the reactor 4. As an alternative, however, the contaminant stream can also be used for driving a turbine.

To reduce the overall mass flow of hydrocarbons necessary for dehydrogenation during the use of the device according to the invention in airplanes or helicopters, the pressure and/or temperature differences on the ground and in the air can be used for the fractionated distillation of kerosene for separating the readily volatile from sparingly volatile constituents of the kerosene, wherein only the sparingly volatile constituents of the fuel are then used for dehydrogenation, thereby reducing the mass flow.

### REFERENCE LIST

1 Fuel reservoir
2 Fuel feed line
3 First discharge line of reactor
4 Reactor
5 Heater
6 Heat exchanger
7 Second discharge line of reactor
8 Cleaning unit
8a Hydrogen outlet
8b Contaminant outlet
9 Outlet of first discharge line
10 Valve arrangement
T_{R} Reaction temperature

1. A device for generating hydrogen gas via dehydrogenation of hydrocarbon fuels, the device comprising:
a fuel reservoir for hydrocarbon fuels, the fuel reservoir connected with a reactor by a fuel feed line to supply fuel to the reactor from the fuel reservoir, the reactor having a first discharge line for returning the residual fuel generated during the dehydrogenation of the supplied fuel to the fuel reservoir, and the reactor interacting with a catalyst, if required, wherein
the fuel reservoir is in contact with a heat exchanger via the fuel feed line and the first discharge line;
the device is adapted for prewarming of the liquid fuel, which is stored in the fuel reservoir, by the heat exchanger and to supply the fuel to the reactor via the fuel feed line;
the reactor has a heater for heating the supplied liquid fuel to reaction temperature (T_{R}), wherein a two-phase mixture is generated in the reactor during dehydrogenation; and
the liquid residual fuel from dehydrogenation of the liquid fuel supplied to the reactor can be returned by the heat exchanger to the fuel reservoir in a cooled state, wherein the reactor has a second discharge line for removing the hydrogen gas and any contaminants therein; and/or
the reaction mixture of liquid residual fuel and hydrogen gas generated during the dehydrogenation of the liquid fuel supplied to the reactor can be supplied to the heat exchanger via the first discharge line for cooling purposes, so as to separate the hydrogen gas from the liquid residual fuel, wherein the first discharge line has an outlet downstream from the heat exchanger for discharging the generated hydrogen gas, along with any contaminants therein.

2. The device of claim 1, wherein the second discharge line or the outlet downstream from the heat exchanger is connected with a cleaning unit.

3. The device of claim 1, wherein the second discharge line or the outlet downstream from the heat exchanger is hooked up to a cleaning unit by a valve arrangement to connect either the second discharge line or the outlet with the cleaning unit.

4. The device of claim 2, wherein the cleaning unit separates hydrogen gas supplied via the second discharge line or the outlet along with any contaminants contained therein.

5. The device of claim 4, wherein the cleaning unit includes a hydrogen outlet for discharging pure hydrogen gas and a contaminant outlet for discharging the separated contaminants.

6. The device of claim 5, wherein the contaminant stream discharged via the contaminant outlet is used for heating the reactor.

7. The device of claim 1, wherein the dehydrogenation of the hydrocarbon fuel is based on the following endothermic reaction:
CₙHₓ→H₂+CₙHₓ₋₂.

8. The device of claim 1, wherein the fuel feed line and first discharge line are part of the heat exchanger.

9. The device of one of claim 1, wherein the heat exchanger operates according to the counter-flow principle.

10. Use of the device of claim 1 for onboard hydrogen gas generation in aircraft, motor vehicles, or other transportation devices.

11. The device of claim 1 for use in an airplane, wherein the reactor can be heated by the bleed-air present in the airplane by exhaust heat from a turbine and/or by exhaust heat from a fuel cell.

12. The device of claim 11, wherein pressure and/or temperature differences between an airplane on the ground and in the air are used for fractionated distillation of the hydrocarbon fuel to separate readily volatile from sparingly volatile constituents of the fuel, wherein the sparingly volatile constituents of the fuel are used for dehydrogenation.

13. A method for generating hydrogen gas via dehydrogenation of hydrocarbon fuels the device of claim 1, wherein the dehydrogenation of hydrocarbon fuel supplied to a reactor is controlled in such a way as to generate hydrogen gas and residual fuel that can be mixed with hydrocarbon fuel stored in a fuel reservoir, wherein
the hydrogen gas generated in the reactor during the dehydrogenation of supplied liquid fuel is directly removed from the reactor via a second discharge line; and/or
the reaction mixture of liquid residual fuel and hydrogen gas generated in the reactor during the dehydrogenation of supplied liquid fuel is removed via a first discharge line and cooled by a heat exchanger to separate the liquid residual fuel from the hydrogen gas, wherein the separated hydrogen gas with any contaminants therein is discharged via an outlet provided in the first discharge line downstream from the heat exchanger.
